(19) United States
(12) Patent Application Publication
(10) Pub. No.: US 2007/0263141 A1
(43) Pub. Date: Nov. 15, 2007

(54) METHOD OF FABRICATING DISPLAY DEVICE

(75) Inventor: Young-chol YANG, Seongnam-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/746,361

(22) Filed: May 9, 2007

(30) Foreign Application Priority Data
May 10, 2006 (KR) 10-2006-0042056

(51) Int. Cl. G02F 1/1335

(52) U.S. Cl. 349/106

(57) ABSTRACT

A method of fabricating a display device has a simple process and reduced manufacturing cost by forming an alignment film on a first insulating substrate; forming a liquid crystal polymer layer in a liquid-crystal state on the alignment film; arranging a mold with a pattern forming part on the first insulating substrate and pressing the mold toward the liquid crystal polymer layer; curing the liquid crystal polymer layer while the mold is being pressed; and separating the mold from the liquid crystal polymer layer to form a phase adjusting plate including a plurality of sub-plates corresponding to the pattern forming part of the mold.

This application claims priority to Korean Patent Application No. 2006-0042056, filed on May 10, 2006, and all the benefits accruing therefrom under 35 U.S.C. §119, the contents of which in its entirety are herein incorporated by reference.

### BACKGROUND OF THE INVENTION

1. Field of the Invention

The present invention relates to a method of fabricating a display device, and more particularly, to a method of fabricating a reflective liquid crystal display.

2. Description of the Related Art

A liquid crystal display (“LCD”) may be classified into a transmissive type, a transflective type or a reflective type, depending on a type of light source used. A transmissive LCD includes a backlight unit disposed in a rear of an LCD panel so that light from the backlight unit passes through the LCD panel. A reflective LCD uses natural or ambient light as a light source and may consume less electric power by limiting use of the backlight unit which accounts for about 70% of the total electric power consumption in the transmissive LCD. A transflective LCD, which has advantages of both the transmissive type and the reflective type, may obtain adequate brightness for the desired purpose regardless of a change in brightness of a surrounding natural light by using both the natural light and the backlight unit.

A quarter wave (“λ/4”) plate is necessary for the transflective LCD to operate normally in a reflecting region. However, it is difficult to form the quarter wave plate only on a necessary portion of the LCD panel due to technical difficulties, and thus is uniformly formed on an entire upper substrate of the LCD panel along with a polarizing plate for processing convenience.

In the aforementioned method, however, the quarter wave plate should be additionally formed on a lower substrate of the LCD panel, which thereby increases manufacturing cost, lowers transmissivity and contrast ratio in a transmitting region of the LCD panel.

### BRIEF SUMMARY OF THE INVENTION

Accordingly, it is an aspect of the present invention to provide a method of fabricating a display device having a simple process and reduced manufacturing cost.

The foregoing and/or other aspects, features and advantages of the present invention are achieved in an exemplary embodiment of the present invention by providing a method of fabricating a display device including forming an alignment film on a first insulating substrate; forming a liquid crystal polymer layer in a liquid-crystal state on the alignment film; arranging a mold with a pattern forming part on the first insulating substrate and pressing the mold toward the liquid crystal polymer layer; curing the liquid crystal polymer layer while the mold is being pressed; and separating the mold from the liquid crystal polymer layer to form a phase adjusting plate including a plurality of sub-plates corresponding to the pattern forming part of the mold.

The method may further include rubbing or optically aligning the alignment film after forming the alignment film and before forming the liquid crystal polymer layer.

The method may further include forming a color filter layer.

The method may further include forming a flattening layer on the phase adjusting plate and forming a color filter layer on the flattening layer.

The method may further include forming a color filter layer on the first insulating substrate before the forming the alignment film.

The color filter layer may include red, green and blue color filters, the red color filter corresponds to a first sub-plate, the green color filter corresponds to a second sub-plate and the blue color filter corresponds to a third sub-plate.

The pattern forming part may be formed by being depressed on one surface of the mold which faces the liquid crystal polymer layer, the patterning forming part comprises a first patterning part corresponding to the first sub-plate, a second patterning part corresponding to the second sub-plate and a third patterning part corresponding to the third sub-plate.

The depths of the first, second and third patterning parts may be different from each other so that the thicknesses of the first, second and third sub-plates are correspondingly different from each other.

The thickness d_{R} of the first sub-plate may be 90% to 110% of λ_{R}/(Δn_{R}·4), the thickness d_{G} of the second sub-plate may be 90% to 110% of λ_{G}/(Δn_{G}·4), and the thickness d_{B} of the third sub-plate may be 90% to 110% of λ_{B}/(Δn_{B}·4). Here, Δn_{R} is refractivity of the first sub-plate, Δn_{G} is refractivity of the second sub-plate, and Δn_{B} is refractivity of the third sub-plate; and λ_{R} is about 630 nm, λ_{G} is about 550 nm, and λ_{B} is about 450 nm.

The first through third sub-plates may be formed at the same time.

The display device includes a thin film transistor substrate including a second insulating substrate facing the first insulating substrate, a thin film transistor formed on the second insulating substrate, a pixel electrode connected to the thin film transistor and a reflecting layer formed in a portion of the pixel electrode, and the phase adjusting plate is formed corresponding to the reflecting layer.

The liquid crystal polymer layer may be cured by at least one of light and heat.

The phase adjusting plate allows light passing therethrough to have a phase difference of λ/4.

The method further includes removing the liquid crystal polymer layer which may remain between the first and second sub-plates, between the second and third sub-plates, and between the first and third sub-plates.

The forming the liquid crystal polymer layer includes; applying a liquid crystal polymer material on the alignment film; and setting a temperature so that the liquid crystal polymer layer becomes a liquid-crystal state.

The liquid crystal polymer layer may be formed by coating or screen printing.

The pressing the mold may be performed at a temperature where the liquid crystal polymer layer is in a liquid-crystal state.

### BRIEF DESCRIPTION OF THE DRAWINGS

The above and/or other aspects, features and advantages of the present invention will become apparent and more readily appreciated from the following description of the exemplary embodiments, taken in conjunction with the accompanying drawings, in which:

FIG. 1 is a plan view illustrating an arrangement of a thin film transistor substrate according to an exemplary embodiment of the present invention;

FIG. 2 is a cross-sectional view taken along line II-II in FIG. 1;

FIG. 3 is a cross-sectional view of a color filter substrate according to the exemplary embodiment of the present invention;

FIGS. 4A through 4G are cross-sectional views to sequentially illustrate a method of fabricating the color filter substrate according to the exemplary embodiment of the present invention; and

FIG. 5 is a cross-sectional view of a color filter substrate according to another exemplary embodiment of the present invention.

### DETAILED DESCRIPTION OF THE INVENTION

Hereinafter, embodiments of the present invention will be described with reference to accompanying drawings, wherein like numerals refer to like elements and repetitive descriptions will be avoided as necessary. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Further, a term of “on” means that a new layer (i.e., film) may be interposed or not interposed between two layers (i.e., films), and a term of “directly on” means that two layers (i.e., films) are in contact with each other. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

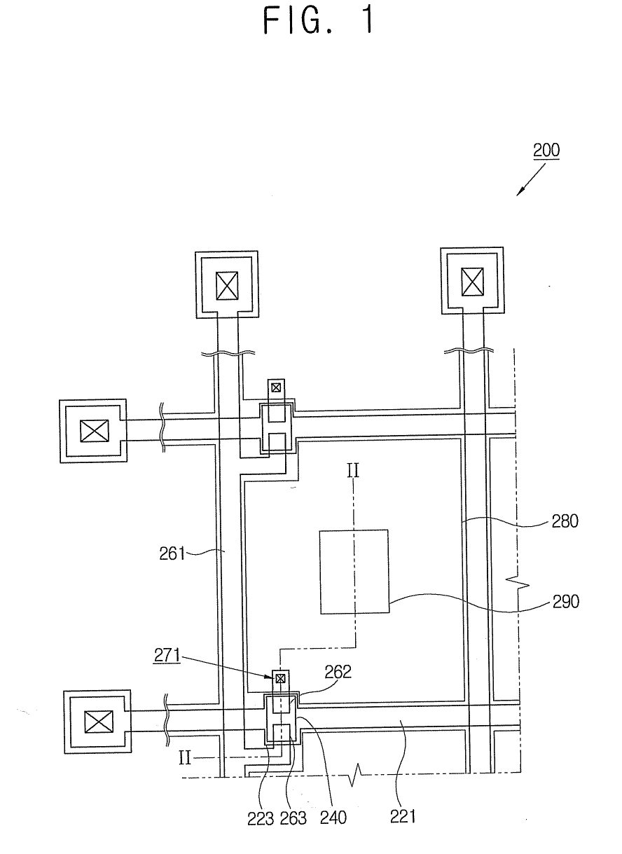

Referring to FIGS. 1 through 3, an LCD panel 1 includes a color filter substrate 100; a thin film transistor substrate 200 facing the color filter substrate 100; a liquid crystal layer 300 interposed between both substrates 100 and 200; and first and second polarizing films 105 and 205 which adhere to the outside surfaces of the color filter substrate 100 and the thin film transistor substrate 200, respectively. The first and second polarizing films 105 and 205 change a polarizing state of incident or exiting light from the LCD panel 1. The first and second polarizing films 105 and 205 may be disposed to have a perpendicular orientation relative to each other.

Describing the color filter substrate 100 first, an alignment film 115 is formed on a first insulating substrate 110. The alignment film 115 is provided for a phase adjusting plate 120 formed thereon to have uniform orientation, thereby obtaining uniform display characteristics. The alignment film 115 may include polyimide polymer and is formed by spin coating or screen printing, for example.

The phase adjusting plate 120 is formed on the alignment film 115 and is formed of a polymer which has a liquid-crystal property in solution or in a melting state, e.g., a liquid crystal polymer. The liquid crystal polymer is a liquid which has some of the qualities of crystals, for example, having orientation. The phase adjusting plate 120 has a certain orientation by the alignment film 115 and passes light through the phase adjusting plate 120 to have a phase difference of λ/4. For example, the phase adjusting plate 120 may change the phase of light incident from the outside from linearly polarized light into circularly polarized light, or alternatively, from circularly polarized light into linearly polarized light.

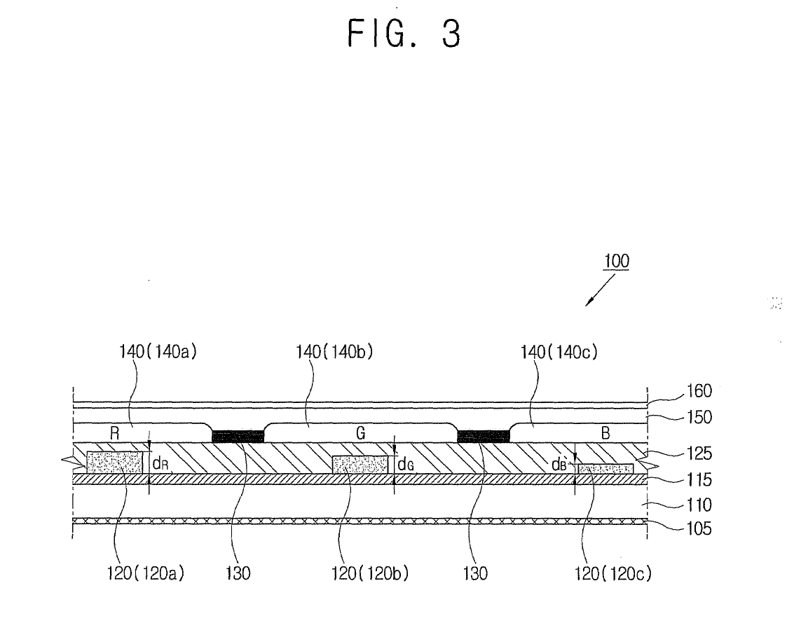

Referring to FIG. 3, the phase adjusting plate 120 includes a first sub-plate 120a corresponding to a red color filter 140a, a second sub-plate 120b corresponding to a green color filter 140b and a third sub-plate 120c corresponding to a blue color filter 140c. When a white color filter (not shown) is provided, a sub-plate may be provided corresponding to the white color filter. The first through third sub-substrates 120a, 120b and 120c have different thicknesses considering different wavelength ranges of red, green and blue lights. In other words, when light with different wavelength ranges pass through the phase adjusting plate 120, the light is reflected on a reflecting layer 290, and then passes through the phase adjusting plate 120 to exit the LCD panel 1, light with different wavelength ranges exit having the same polarizing property or optical characteristics. Preferably, the thickness d_{R} of the first sub-plate 120a is 90% to 110% of λ_{R}/(Δn_{R}·4); the thickness d_{G} of the second sub-plate 120b is 90% to 110% of λ_{G}/(Δn_{G}·4); and the thickness d_{B} of the third sub-plate 120c is 90% to 110% of λ_{B}/(Δn_{B}·4). Here, Δn_{R} is refractivity of the first sub-plate 120a, Δn_{G} is refractivity of the second sub-plate 120b, and Δn_{B} is refractivity of the third sub-plate 120c; and λ_{R} is about 630 nm, λ_{G} is about 550 nm, and λ_{B} is about 450 nm. The first through third sub-plates 120a, 120b and 120c may be formed corresponding to the reflecting layer 290 provided in each pixel region. The first through third sub-plates 120a, 120b and 120c are manufactured in the same layer at the same time.

Hereinafter, when the phase adjusting plate 120 is used for the display device, a path and a polarizing state of light in a reflecting region will be described. Here, liquid crystals are vertical alignment (“VA”) and normally display a black image or black state when not being applied with a voltage. Generally, light from a natural light source into a color filter layer 140 is changed into linearly polarized light by producing a phase difference of λ/4 (90°) while passing through the first polarizing film 105. The linearly polarized light is changed into circularly polarized light while passing through the phase adjusting plate 120. The circularly polarized light does not change a polarizing orientation, (e.g., right circularly polarized light keeps the right circular polarized light and left circularly polarized light keeps the left circular polarized light), under the normal black state although passing through the liquid crystal layer 300, and thus the circularly polarized light is reflected on the reflecting layer 290 while maintaining the same polarizing property and optical characteristics. The circularly polarized light reflected on the reflecting layer 290 is changed into linearly polarized light by producing a phase difference λ/4 (90°) while passing through the phase adjusting plate 120. Accordingly, a phase difference of λ/2 (180°) is produced between the light passing through the phase adjusting plate 120 to exit to the outside and the light incident from the outside, and the resultant exiting light becomes a black state as having a different polarizing state from the first polarizing film 105. When a voltage is applied, a circularly polarized light will change its circular polarization orientation from left to right or from right to left after passing through the liquid crystal layer 300. The circularly polarized light is changed into linearly polarized light when reflected on the reflecting layer 290 and passed through the phase adjusting plate 120, which becomes a white state as having the same polarizing state as the first polarizing film 105.

A flattening layer 125 is formed on the phase adjusting plate 120. The flattening layer 125 protects the phase adjusting plate 120 and is provided with a flat surface.

A black matrix 130 is formed in a lattice shape on the flattening layer 125. The black matrix 130 is disposed between the red, green and blue filters 140a, 140b and 140c to divide the filters, and prevents light from being irradiated directly to the thin film transistor (T) disposed on the thin film transistor substrate 200. The black matrix 130 is typically made of a photoresist organic material including a black pigment. The black pigment may include carbon black or titanium oxide, for example, but is not limited thereto.

The color filter layer 140 includes the red, green and blue filters 140a, 140b and 140c, which are alternately disposed and separated by the black matrix 130. The color filter layer 140 endows colors to light irradiated from the backlight unit (not shown) and passed through the liquid crystal layer 300. The color filter layer 140 is generally made of a photoresist organic material. The color filter layer 140 is formed with a coloring photoresist organic material by a pigment dispersion method.

An overcoat layer 150 is formed on the black matrix 130 and the color filter layer 140. The overcoat layer 150 protects the color filter layer 140 and is provided with a flat surface. The overcoat layer 150 is generally made of an acrylic epoxy material.

A common electrode 160 is formed on the overcoat layer 150. The common electrode 160 is made of a transparent conductive material such as indium tin oxide (“ITO”) or indium zinc oxide (“IZO”) and applies a voltage to the liquid crystal layer 300 along with a pixel electrode 280 on the thin film transistor substrate 200. The common electrode 160 does not have a broken or cut pattern and covers the entire overcoat layer 150.

Hereinafter, the thin film transistor substrate 200 will be described.

A gate wiring 221 and 223 is formed on a second insulating substrate 210. The gate wiring 221 and 223 may be a single layer or multilayers. The gate wiring 221 and 223 includes a gate line 221 extending transversely, as illustrated in FIG. 1, and a gate electrode 223 of a thin film transistor (T) connected to the gate line 221. The gate wiring 221 and 223 may further include a common electrode line which overlaps the pixel electrode 280 to form a storage capacitor.

A gate insulating layer 230 is made of silicon nitride (“SiNx”) and is formed on the second insulating substrate 210 to cover the gate wiring 221 and 223 and to expose an end portion of the gate line 221.

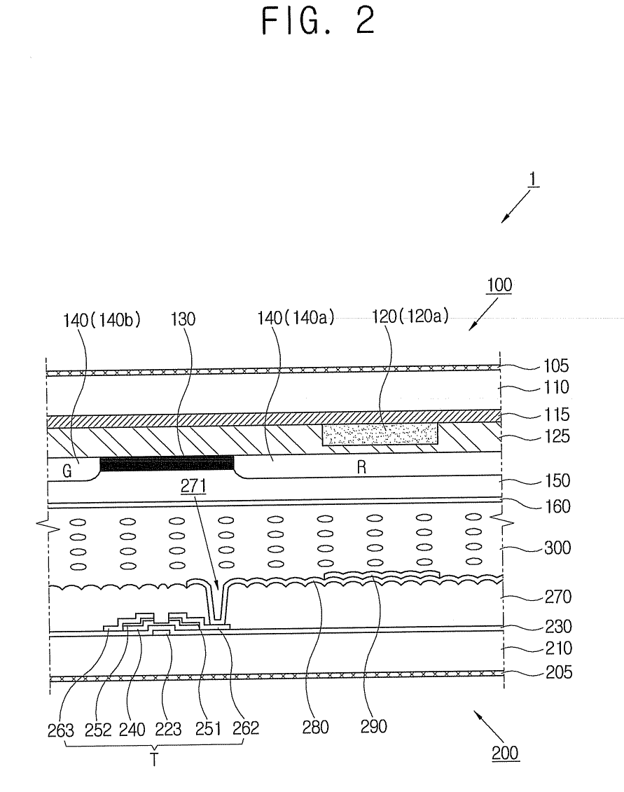

A semiconductor layer 240 made of amorphous silicon is formed on the gate insulating layer 230. An ohmic contact layer 251 and 252 made of n+hydrogenated amorphous silicon which and highly doped with silicide or n-type impurities is formed on the semiconductor layer 240. The ohmic contact layer 251 and 252 is divided into two parts, the gate electrode 223 being disposed therebetween, as best seen with reference to FIG. 2.

A data wiring 261, 262 and 263 is formed on the ohmic contact layer 251 and 252 and the gate insulating layer 230. The data wiring 261, 262 and 263 may be a metal single layer or metal multilayers. The data wiring 261, 262 and 263 includes a data line 261 extending perpendicularly to cross the gate line 221 to define a pixel region, a source electrode 263 branched from the data line 261 and extending over the ohmic contact layer 252 and a drain electrode 262 separated from the source electrode 263 with the gate electrode 223 being disposed therebetween.

A passivation layer 270 includes silicon nitride (“SiNx”), an a-Si:C:O layer and an a-Si:O:F layer which are deposited by plasma enhanced chemical vapor deposition (“PECVD”), or an acrylic organic insulating layer and is formed on the data wiring 261, 262 and 263 and a portion of the semiconductor layer 240 which is not covered with the data wring 261, 262 and 263. A contact hole 271 is formed in the passivation layer 270 to expose the drain electrode 262.

The pixel electrode 280 is formed on the passivation layer 270. The pixel electrode 280 is made of a transparent conductive material such as ITO or IZO and fills the pixel region. The pixel electrode 280 is connected to the drain electrode 262 through the contact hole 271, thereby being electrically connected to the thin film transistor (T).

The reflecting layer 290 is formed on the pixel electrode 280. The pixel region formed by the data line 261 and the gate line 221 is divided into a transmitting region where the reflecting layer 290 is not formed and a reflecting region where the reflecting layer 290 is formed. The LCD having the aforementioned configuration is referred to as a transflective LCD. Light from the backlight unit (not shown) passes through the LCD panel 1 to exit to the outside in the transmitting region, and light from the outside is reflected on the reflecting layer 290 and exits to the outside through the LCD panel 1 in the reflecting region. The reflecting region 290 may employ aluminum, silver or double layers of aluminum/molybdenum, for example, but is not limited thereto.

In the present invention, the phase adjusting plate 120 is not necessary on the thin film transistor substrate 200 and is formed only on a necessary portion of the color filter substrate 100, and thus transmissivity and contrast ratio are not decreased. Furthermore, manufacturing cost is reduced.

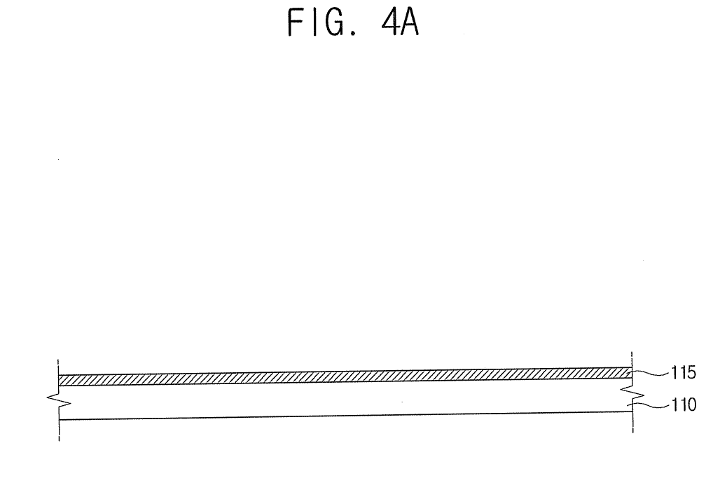

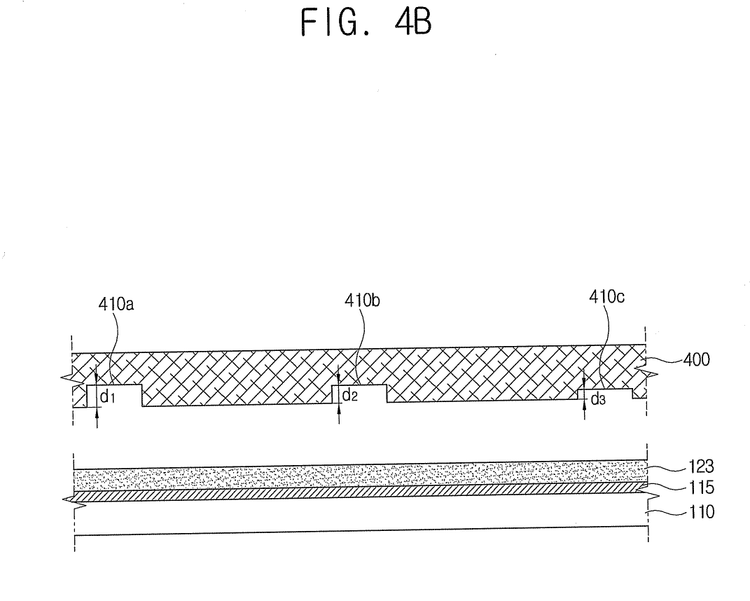

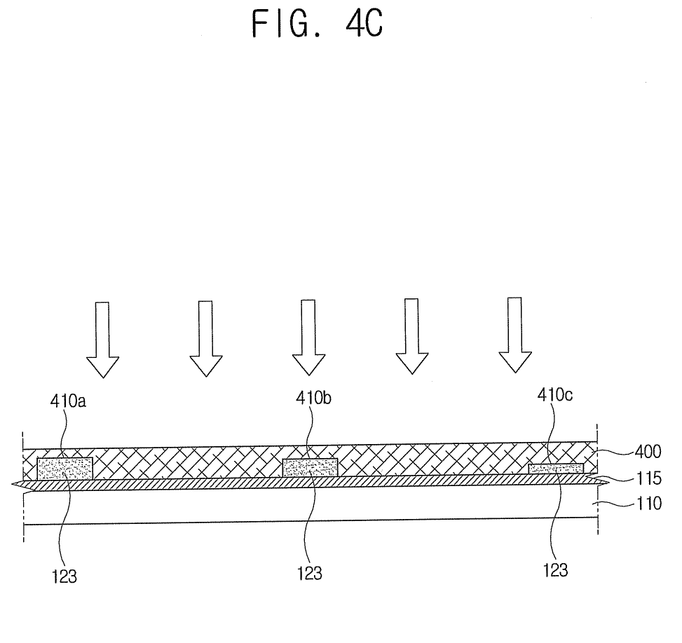

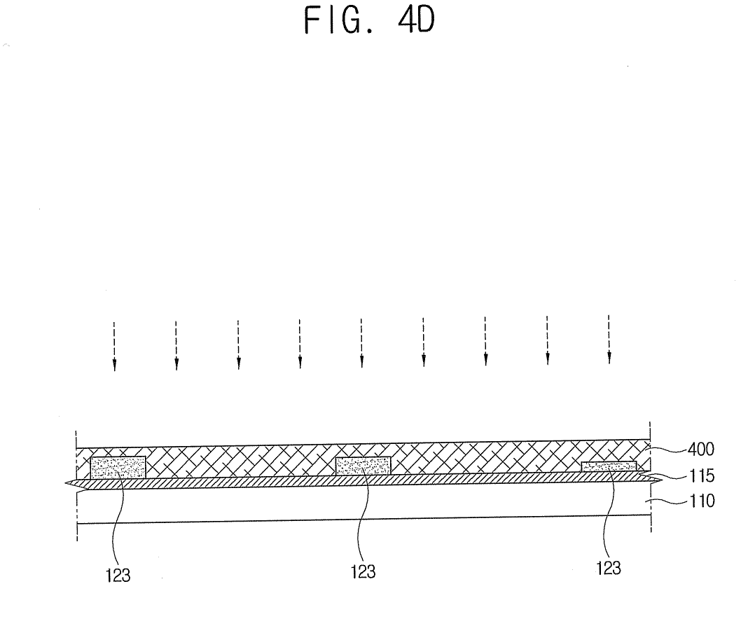

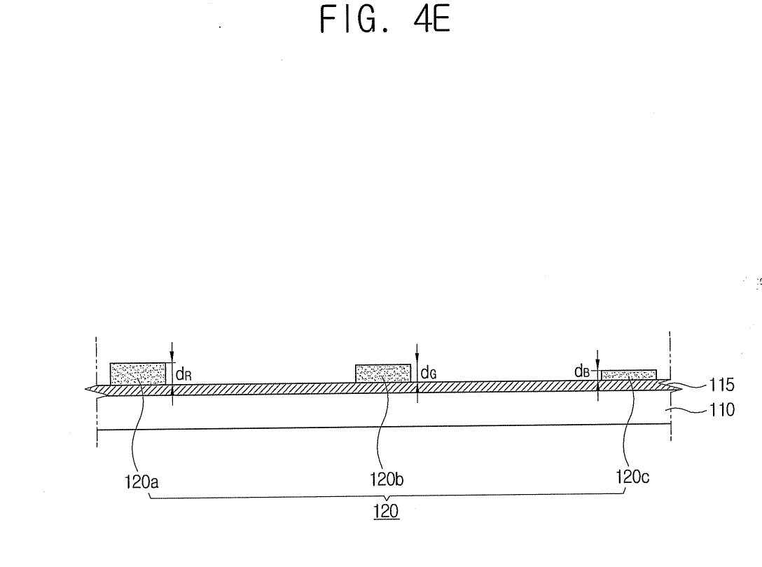

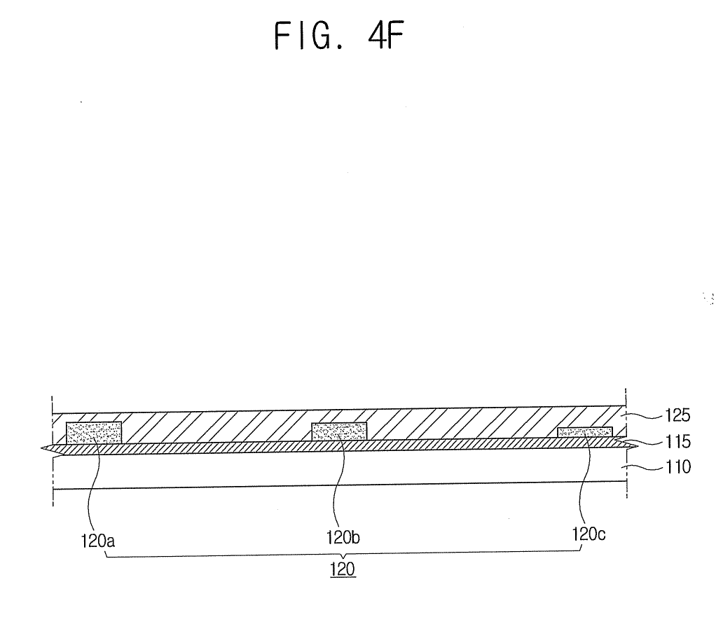

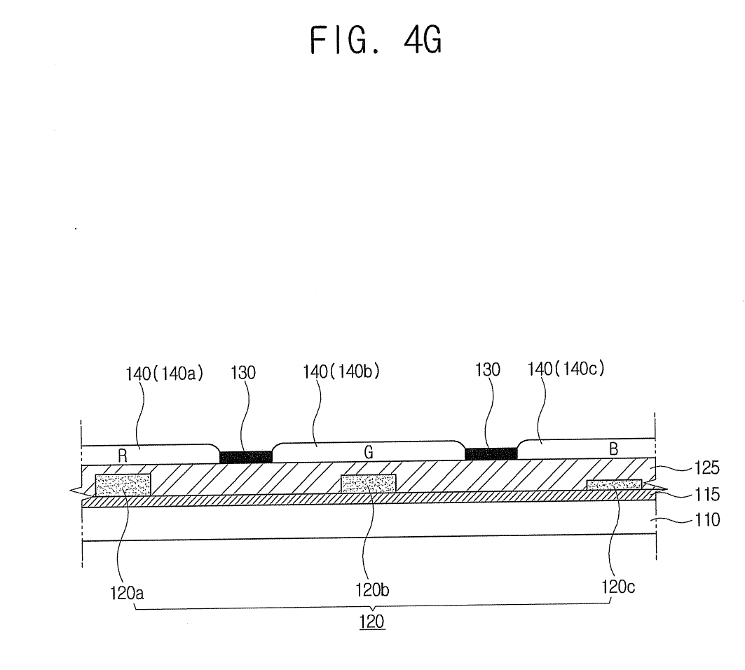

Hereinafter, a method of fabricating the color filter substrate according to an exemplary embodiment of the present invention will be described with reference to FIGS. 4A through 4G.

Referring to FIG. 4A, the alignment film 115 is formed on the entire surface of the first insulating substrate 110. The alignment film 115 may include polyimide polymer and is formed by spin coating or screen printing. Then, the alignment film 115 is rubbed or optically aligned to have a certain orientation. Accordingly, the phase adjusting plate 120 obtains the certain orientation, and light passing through the phase adjusting plate 120 obtains a phase difference of λ/4 in an exemplary embodiment.

Referring to FIG. 4B, a liquid crystal polymer layer 123 in a liquid-crystal state is formed on the alignment film 115. A liquid crystal polymer layer 123 is formed by applying a liquid crystal polymer material to the alignment film 115. The liquid crystal polymer material has a liquid-crystal property in solution or in a melting state, e.g., a liquid which has some of the qualities of crystals, for example, having orientation. The liquid crystal polymer layer 123 may be formed by spin coating or screen printing. Then, a mold 400 for manufacturing a display device having pattern forming part 410 (e.g., 410a, 410b and 410c) is disposed over the liquid crystal polymer layer 123. The pattern forming part 410a, 410b and 410c is provided to form the first through third sub-plates 120a, 120b and 120c, respectively, and formed by being depressed on one surface of the mold 400. The pattern forming part 410 includes a first patterning part 410a, a second patterning part 410b and a third patterning part 410c. The first patterning part 410a corresponds to the first sub-plate 120a, the second patterning part 410b corresponds to the second sub-plate 120b, and the third patterning part 410c corresponds to the third sub-plate 120c. The mold 400 is disposed considering positions of the first through third sub-plate 120a, 120b and 120c. In detail, the first, second and third pattering parts 410a, 410b and 410c are aligned to correspond to a red color filter (R), a green color filter (G) and a blue color filter (B), respectively, and to correspond to the reflecting layer 290 to be formed in each pixel region. Further, the depths d1, d2 and d3 of the patterning parts 410a, 410b and 410c, respectively, are different from each other, and are substantially the same as the thicknesses d_{R}, d_{G} and d_{B} of the corresponding sub-plates 120a, 120b and 120c. In particular, the patterning parts 410a, 410b and 410c are manufactured so that the thickness d_{R} of the first sub-plate 120a (see FIG. 4E) is 90% to 110% of λ_{R}/(Δn_{R}·4); the thickness d_{G} of the second sub-plate 120b (see FIG. 4E) is 90% to 110% of λ_{G}/(Δn_{G}·4); and the thickness d_{B} of the third sub-plate 120c (see FIG. 4E) is 90% to 110% of λ_{B}/(Δn_{B}·4). Here, Δn_{R} is refractivity of the first sub-plate 120a, λn_{G} is refractivity of the second sub-plate 120b, and λn_{B} is refractivity of the third sub-plate 120c; and λ_{R} is about 630 nm, λ_{G} is about 550 nm, and λ_{B} is about 450 nm.

Referring to FIG. 4C, temperature is set so that the liquid crystal polymer layer 123 becomes in a liquid-crystal state, then the mold 400 is pressed toward the first insulating substrate 110. In other words, it is preferable that the mold 400 is pressed under a temperature where the liquid crystal polymer layer 123 is in a liquid-crystal state in order for light passing through the phase adjusting plate 120 to have a phase difference of λ/4. Accordingly, the liquid crystal polymer layer 123 fills the patterning forming parts 410a, 410b and 410c, and other portions of the liquid crystal polymer layer 123 except the patterning parts 410a, 410b and 410c are removed while pressing the mold 400. Meanwhile, raising the temperature for the liquid crystal polymer layer 123 to be a liquid-crystal state may be processed after forming the alignment film 115 and before arranging the mold 400.

Referring to FIG. 4D, the liquid crystal polymer layer 123 is cured by irradiating light thereon as illustrated by the phantom arrows. Here, the mold 400 is made of a material capable of transmitting light, and the light may be ultraviolet rays.

Referring to FIG. 4E, the mold 400 is separated from the substrate, thereby forming the phase adjusting plate 120 including the first through third sub-plates 120a, 120b and 120c. The thickness d_{R} of the first sub-plate 120a is 90% to 110% of λ_{R}/(Δn_{R}·4); the thickness d_{G} of the second sub-plate 120b is 90% to 110% of λ_{G}/(Δn_{G}·4); and the thickness d_{B} of the third sub-plate 120c is 90% to 110% of λ_{B}/(Δn_{B}·4). Here, Δn_{R} is refractivity of the first sub-plate 120a, Δn_{G} is refractivity of the second sub-plate 120b, and Δn_{B} is refractivity of the third sub-plate 120c; and λ_{R} is about 630 nm, λ_{G} is about 550 nm, and λ_{B} is about 450 nm. Further, light passing through the phase adjusting plate 120 obtains a phase difference of λ/4. Meanwhile, after removing the mold 400, a process of removing the liquid crystal polymer layer 123 (see FIG. 4D) which may remain between the first sub-plate 120a and the second sub-plate 120b, between the second sub-plate 120b and the third sub-plate 120c, and between the first sub-plate 120a and the third sub-plate 120c may be further performed.

Accordingly, the first through third sub-plates 120a, 120b and 120c may be manufactured at the same time by a molding process, and thus simplifying a manufacturing process and reducing manufacturing cost.

Referring to FIG. 4F, the flattening layer 125 is formed on the phase adjusting plate 120 to protect and flatten a surface of the phase adjusting plate 120.

Referring to FIG. 4G, the black matrix 130 in a lattice shape and the color filter layer 140 are formed on the flattening layer 125. The black matrix 130 is typically made of a photoresist organic material including a black pigment. The black pigment may be carbon black or titanium oxide, for example, but is not limited thereto. The color filter layer 140 is formed with a coloring photoresist organic material of red, green and blue by a pigment dispersion method. The color filter layer 140 includes the red, green and blue filters 140a, 140b and 140c which are alternately disposed and separated by the black matrix 130. The red color filter 140a corresponds to the first sub-plate 120a, the green color filter 140b corresponds to the second sub-plate 120b, and the blue color filter 140c corresponds to the third sub-plate 120c.

Then, referring again to FIG. 3, the overcoat layer 150 is formed on the black matrix 130 and the color filter layer 140, and the common electrode 160 is formed only on the overcoat layer 150, thereby completing the color filter substrate 100.

In the present invention, the phase adjusting plate 120 is not necessary on the thin film transistor substrate 200 and is formed on a necessary portion of the color filter substrate 100, and thus transmissivity and contrast ratio is not decreased in the transmitting region.

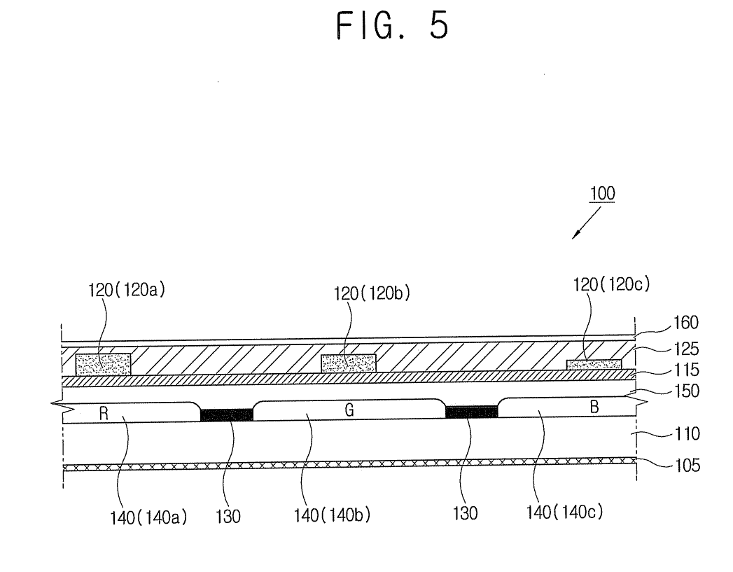

According to another exemplary embodiment of the present invention with reference to FIG. 5, a black matrix 130, a color filter layer 140 and an overcoat layer 150 may be interposed between a first insulating substrate 110 and an alignment film 115. Namely, the black matrix 130, the color filter layer 140 and the overcoat layer 150 may be formed before a formation of the alignment film 115 and a phase adjusting plate 120.

Although a few exemplary embodiments of the present invention have been shown and described, it will be appreciated by those skilled in the art that changes may be made in these exemplary embodiments without departing from the principles and spirit of the present invention, the scope of which is defined in the appended claims and their equivalents.

What is claimed is:

1. A method of fabricating a display device comprising:
forming an alignment film on a first insulating substrate;
forming a liquid crystal polymer layer in a liquid-crystal state on the alignment film;
arranging a mold with a pattern forming part on the first insulating substrate and pressing the mold toward the liquid crystal polymer layer;
curing the liquid crystal polymer layer while the mold is being pressed; and
separating the mold from the liquid crystal polymer layer to form a phase adjusting plate including a plurality of sub-plates corresponding to the pattern forming part of the mold.

2. The method according to claim 1, further comprising rubbing or optically aligning the alignment film after the forming the alignment film and before the forming the liquid crystal polymer layer.

3. The method according to claim 2, further comprising forming a color filter layer.

4. The method according to claim 3, further comprising forming a flattening layer on the phase adjusting plate,
wherein the color filter layer is formed on the flattening layer.

5. The method according to claim 3, wherein the color filter layer is formed on the first insulating substrate before the forming the alignment film.

6. The method according to claim 3, wherein the color filter layer comprises red, green and blue color filters,
the red color filter corresponds to a first sub-plate, the green color filter corresponds to a second sub-plate and the blue color filter corresponds to a third sub-plate.

7. The method according to claim 6, wherein the pattern forming part is formed by being depressed on one surface of the mold which faces the liquid crystal polymer layer,
the patterning forming part comprises a first patterning part corresponding to the first sub-plate, a second patterning part corresponding to the second sub-plate and a third patterning part corresponding to the third sub-plate.

8. The method according to claim 7, wherein the depths of the first, second and third patterning parts are different from each other so that the thicknesses of the first, second and third sub-plates are different from each other.

9. The method according to claim 8, wherein the thickness d_{R} of the first sub-plate is 90% to 110% of λ_{R}/(λn_{R}·4), the thickness d_{G} of the second sub-plate is 90% to 110% of λ_{g}/(Δn_{G}·4), and the thickness d_{B} of the third sub-plate is 90% to 110% of λ_{B}/(Δn_{B}·4), wherein Δn_{R} is refractivity of the first sub-plate, Δn_{G} is refractivity of the second sub-plate, and Δn_{B} is refractivity of the third sub-plate; and λ_{R} is about 630 nm, λ_{G} is about 550 nm, and λ_{B} is about 450 nm.

10. The method according to claim 9, wherein the first through third sub-plates are formed at the same time.

11. The method according to claim 9, wherein the display device comprises a thin film transistor substrate including a second insulating substrate facing the first insulating substrate, a thin film transistor formed on the second insulating substrate, a pixel electrode connected to the thin film transistor and a reflecting layer formed in a portion of the pixel electrode, and the phase adjusting plate is formed corresponding to the reflecting layer.

12. The method according to claim 9, wherein the phase adjusting plate allows light passing therethrough to have a phase difference of λ/4.

13. The method according to claim 6, further comprising removing the liquid crystal polymer layer which may remain between the first and second sub-plates, between the second and third sub-plates, and between the first and third sub-plates.

14. The method according to claim 13, further comprising removing the liquid crystal polymer layer which may remain between the first and second sub-plates, between the second and third sub-plates, and between the first and third sub-plates while the mold is being pressed.

15. The method according to claim 1, wherein the forming the liquid crystal polymer layer comprises; applying a liquid crystal polymer material on the alignment film; and setting a temperature so that the liquid crystal polymer layer becomes a liquid-crystal state.

16. The method according to claim 15, wherein the liquid crystal polymer layer is formed by coating or screen printing.

17. The method according to claim 1, wherein the pressing the mold is performed at a temperature where the liquid crystal polymer layer is in a liquid-crystal state.

18. The method according to claim 1, wherein the liquid crystal polymer layer is cured by at least one of light and heat.
